(19) United States
(12) Patent Application Publication
(10) Pub. No.: US 2004/0118035 A1
(43) Pub. Date: Jun. 24, 2004

(54) Olefin polymerization catalyst and process and polymer, polymer derivatives, lubricants and fuels thereof

(76) Inventor: Saleem Al-Ahmad, Euclid, OH (US)

Correspondence Address: Jeffrey F Munson, The Lubrizol Corporation, 29400 Lakeland Boulevard, Wickliffe, OH, 44092-2298, US

(21) Appl. No.: 10/258,012

(22) PCT Filed: May 15, 2001
(86) PCT No.: PCT/US01/15532

(51) Int. Cl. C10L 1/22; C10L 1/12; C10M 101/00; B01J 31/00

(52) U.S. Cl. 44/415; 44/457; 44/459; 508/542; 508/591; 502/155; 502/167; 502/168

(57) ABSTRACT

This invention is directed to a catalyst and an associated process for polymerizing olefins or olefin-containing compounds, to corresponding olefin polymers, to derivatives of the olefin polymers, and to lubricant and fuel compositions that include the olefin polymers or their derivatives. The polymerization catalyst is a metal complex and optional cocatalyst where the metal complex is formed from a bidentate ligand having a nitrogen coordinating group and a second coordinating group selected from oxygen, sulfur, selenium and tellurium groups and a metal compound where the metal is a transition metal, boron, aluminum, germanium or tin. Highly branched and reactive ethylene polymers are formed from the catalyst and process of the present invention. The ethylene polymers and their derivatives are useful in various applications including as performance additives in lubricants and fuels.

This application claims the benefit of U.S. Provisional Application No. 60/204,111 filed May 15, 2000.

### BACKGROUND OF THE INVENTION

1. Field of the Invention

The present invention involves a novel catalyst to polymerize olefins or olefin-containing compounds, a polymerization process, a polymer, derivatives of the polymer, and lubricants and fuels that include the polymer or derivatives of the polymer. The catalyst provides a route to a polyethylene having unique properties and utility in various commercial applications including as a performance additive or as an intermediate to performance additives for use in lubricants and fuels.

2. Description of the Related Art

Homopolymers and copolymers of olefins and olefin-containing compounds are useful materials in various areas of commerce. Consequently, new polymerization catalysts and polymerization processes using the catalysts are constantly sought that provide processing advantages or unique polymers.

U.S. Pat. No. 5,811,379 filed Jun. 17, 1996 (Rossi et al.) and U.S. Pat. No. 6,017,859 filed Jul. 2, 1998 (Rossi et al.) disclose olefin polymerization catalysts from transition metals complexed to bidentate ligands by heteroatoms and corresponding olefin polymers having branching and at least 30% terminated by a vinyl group.

U.S. Pat. No. 5,880,241 filed Jan. 24, 1996 (Brookhart et al.) and U.S. Pat. No. 5,880,323 filed Jul. 10, 1997 (Brookhart et al.) and U.S. Pat. No. 5,866,663 filed Jul. 10, 1997 (Brookhart et al.) disclose highly branched polyolefins including polyethylenes.

U.S. Pat. No. 6,063,973 filed Mar. 19, 1999 (Sen et al.) disclose highly branched polyethylene fluids having a molecular weight from about 300 to 30,000.

U.S. Pat. No. 6,057,466 filed Sep. 29, 1997 (Starzewsli et al.) disclose catalysts from palladium and bidentate ligands complexed to the metal by heteroatoms for polymerizing ethylenically unsaturated compounds.

U.S. Pat. No. 6,103,657 filed Jun. 23, 1998 (Murray) discloses catalysts from selected transition metals complexed to bidentate ligands by heteroatoms that are useful for polymerizing olefins.

U.S. Pat. No. 6,127,497 filed Jun. 17, 1997 (Matsunaga et al.) disclose a process for polymerizing olefins using a catalyst from a transition metal compound and a bidentate ligand.

U.S. Pat. No. 6,174,975 filed Jan. 13, 1998 (Johnson et al.) disclose a process for polymerizing olefins using a catalyst from nickel compounds chelated with oxygen and nitrogen atoms.

Using the novel catalyst and polymerization process of the present invention, ethylene is polymerized to a polymer having unique properties. This ethylene polymer and derivatives thereof are useful in various areas of commerce. The catalyst and process of the present invention are highly efficient in the amount of polymer produced per amount of catalyst and exceptionally durable in the retention of catalyst activity over time.

### SUMMARY OF THE INVENTION

It is an object of the present invention to prepare novel polymers.

It is a further object of the invention to prepare novel polyethylenes.

Another object of this invention is an improved polymerization process.

The objects, advantages and embodiments of the present invention are in part described in the specification and in part are obvious from the specification or from the practice of this invention. Therefore, it is understood that the invention is claimed as described or obvious as falls within the scope of the appended claims.

It has been discovered that certain metal complexes and, optionally, an activating compound capable of reacting with the metal complex to form a catalyst, are a catalyst for the polymerization of olefins or olefin-containing compounds. The metal complexes are prepared by reacting a metal compound with a bidentate ligand. The metal of the metal compound is selected from the group consisting of transition metals, boron, aluminum, germanium and tin. The bidentate ligand has a nitrogen-coordinating group and a second coordinating group that is an oxygen, sulfur, selenium or tellurium group. The bidentate ligand reacting with the metal compound to form a five-membered ring complex is selected from the group consisting of

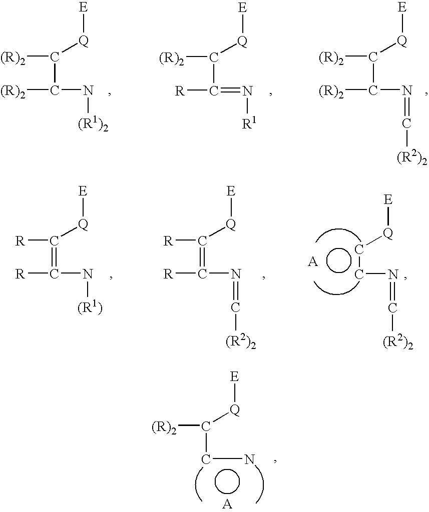

wherein Q is O, S, Se or Te; E, R, R¹ and R² are independently hydrogen, hydrocarbyl, cationic counterion or taken together to form a ring are hydrocarbylene, provided that E is hydrocarbyl or hydrocarbylene when Q is O; and A is a divalent group that forms an aromatic ring and can include N, O and S atoms. The bidentate ligand reacting with the metal compound to form a six- or seven-membered ring complex is selected from the group consisting of

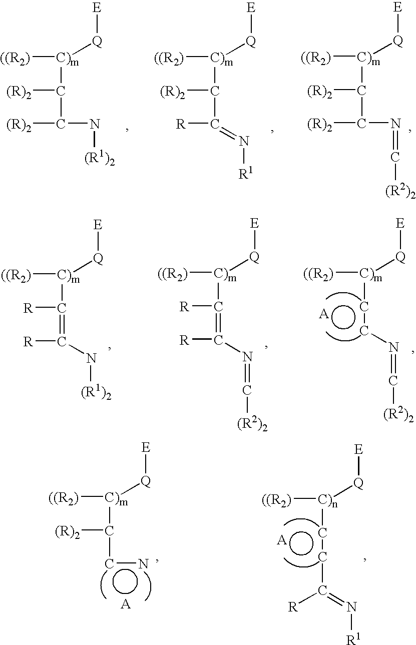

wherein Q is O, S, Se or Te; M is 1 or 2; E, R, R¹ and R² are independently hydrogen, hydrocarbyl, cationic counterion or taken together to form a ring are hydrocarbylene provided that E is hydrocarbyl or hydrocarbylene when Q is O; A is a divalent group that forms an aromatic ring and can include N, O and S atoms; and n is 0 or 1.

An embodiment of the present invention is the catalyst where the metal of the metal compound is cobalt, nickel, palladium or platinum and the bidentate ligand has a nitrogen-coordinating, group and a second coordinating group that is a sulfur group.

Another embodiment of the present invention is a process for polymerizing olefins or olefin-containing compounds comprising contacting olefins or olefin-containing compounds under polymerization conditions with the catalyst of the present invention.

A further embodiment of the present invention is an olefin polymer prepared by the process of contacting an olefin or olefin-containing compound with the catalyst under polymerization conditions.

A still further embodiment of the present invention is a polyethylene polymer that has a number average molecular weight of less than 10,000, branching of about 100 or more methyl-ended branches per 1,000 methylene carbon atoms and a reactivity with the acylating agent maleic anhydride of about 70% by weight or greater.

Other embodiments of the invention are dispersant and detergent derivatives from the olefin polymer of the present invention to include alkenylsuccinic acids and derivatives thereof, alkylphenols and derivatives thereof, and alkylarenes and derivatives thereof.

Additional embodiments of the invention are lubricant and fuel compositions that include the olefin polymer of the present invention, its dispersant derivatives or its detergent derivatives.

### DETAILED DESCRIPTION OF THE INVENTION

The catalyst of the present invention finds use in the polymerization of olefins or olefin-containing compounds.

Polymerization is defined herein to be the combining of two or more monomers of olefin or olefin-containing compound. The polymerization can involve a single monomer to give homopolymers or a mixture of two or more monomers to give copolymers.

The olefins are acyclic or cyclic alkenes having a double bond or polyenes having two or more double bonds. The olefins are preferably C₂ to C₅₀ alkenes, more preferably C₂ to C₂₀ alkenes and most preferably C₂ to C₂₀ 1-alkenes such as ethylene, propylene, 1-butene, isobutylene, 1-octene and 1-decene.

The olefin-containing compounds are compounds that have a polymerizable double bond in addition to one or more other functional groups. The olefin-containing compounds preferably contain a vinyl group (CH₂═CH—) in addition to one or more other functional groups such as styrene, carboxylic acids and their esters containing a vinyl group in the carboxylic acid portion or in the alkoxy portion of the ester, and vinyl ethers.

Polymerizations using the catalyst of the present invention may involve homopolymers of an olefin or of an olefin-containing compound, or copolymers of a mixture of two or more olefins, of a mixture of two or more olefin-containing compounds, or of a mixture of one or more olefins and one or more olefin-containing compounds.

The catalyst of the present invention comprises a metal complex and, optionally, an activating compound capable of reacting with the metal complex to form the catalyst.

The metal complex is prepared by reacting a metal compound with a bidentate ligand. The metal of the metal compound is selected from the group consisting of transition metals, boron, aluminum, germanium and tin. Especially preferred metals are cobalt, nickel, palladium and platinum. Examples of metal compounds useful in forming metal complexes are NiBr₂(1,2-dimethoxyethane), NiCl₂(1,2-dimethoxyethane), [Pd(CH₃)(CH₃CN)(1,5-cyclooctadiene)]SbF₆ and CoCl₂.

The bidentate ligand, that reacts with the metal compound to form the metal complex, has a nitrogen-coordinating group and a second coordinating group that is an oxygen, sulfur, selenium or tellurium group. Especially preferred for the second coordinating group is a sulfur group.

The bidentate ligand that reacts with the metal compound to form a five-membered ring chelate metal complex is selected from the group consisting of

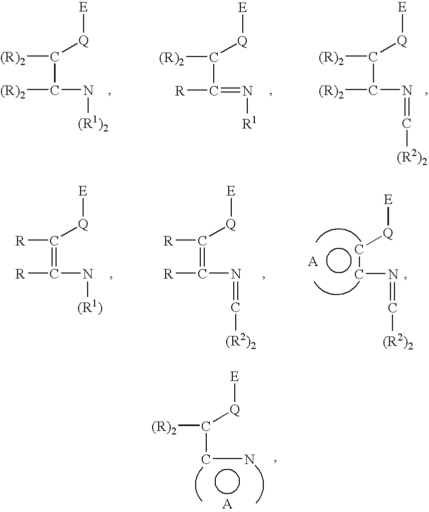

wherein Q is O, S, Se or Te; E, R, R¹ and R² are independently hydrogen, hydrocarbyl, cationic counterion or taken together to form a ring are hydrocarbylene provided that E is hydrocarbyl or hydrocarbylene when Q is O; and A is a divalent group that forms an aromatic ring and can include N, O and S atoms. Hydrocarbyl and hydrocarbylene throughout this application are respectively univalent and divalent radicals of one or more carbon atoms that are predominately hydrocarbon in nature, but may have nonhydrocarbon substituent groups and may contain heteroatoms.

The bidentate ligand that reacts with the metal compound to form a six- or seven-membered ring chelate metal complex is selected from the group consisting of

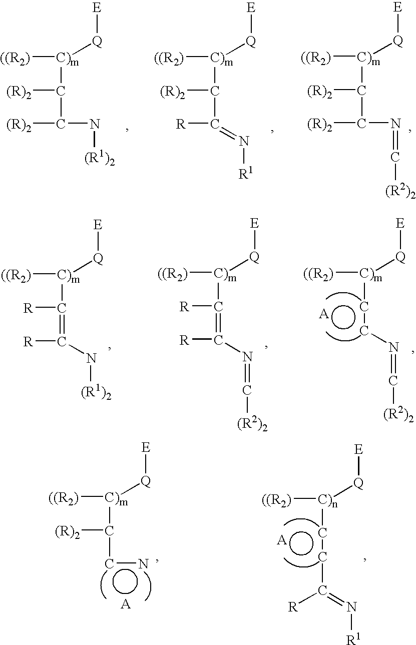

wherein Q is O, S, Se or Te; m is 1 or 2; E, R, R¹ and R² are independently hydrogen, hydrocarbyl, cationic counterion or taken together to form a ring are hydrocarbylene provided that E is hydrocarbyl or hydrocarbylene when Q is O; A is a divalent group that forms an aromatic ring and can include N, O and S atoms; and n is 0 or 1.

Instances of bidentate ligands and of metal complexes, prepared by reaction of these bidentate ligands with metal compounds, and their preparation are provided in the non-limiting examples listed below. For the reaction to form the metal complexes, a mole ratio of metal compound to bidentate ligand of 1:1-2 may be used while a mole ratio of 1:1-1.5 is preferred. The crystalline complex of Example 10 hereinbelow was prepared from NiBr₂.1,2-dimethoxyethane and a bidentate ligand having one N and one S coordinating group where the ligand was an imine formed by condensing 2,6-diisopropylaniline with 3-(methylthio)-2-butanone. The complex of Example 10 was found by x-ray crystallography to be a distorted tetrahedral configuration around the Ni atom.

The activating compounds or cocatalysts are compounds that activate the metal complexes in any manner that allows catalytic polymerization to occur via insertion or coordination polymerization. Examples of activating compounds include alkylaluminoxanes, organoaluminum compounds such as aluminum alkyls and alkylaluminum halides, aluminum halides, hydrocarbylborons, halogenated hydrocarbylborons such as fluorohydrocarbylboron compounds, acids of noncoordinating anions, acidic aluminas, acidic silicas, acidic clays, acidic zirconias and Lewis acids not already listed above. Methylaluminoxane is a preferred activating compound. The mole ratio of the metal complex to activating compound is 1:1-10,000, preferably 1:1-3,000 and more preferably 1:1-1,000.

The process of the present invention for polymerizing olefins or olefin-containing compounds involves contacting olefins or olefin-containing compounds under polymerizing conditions with the catalyst of the present invention.

The polymerization process may involve solution, slurry (or suspension) or gas phase processing conditions as described in WO 98/49208, the disclosure of which is incorporated herein by reference.

The polymerization process may involve supported catalysts that use inorganic solids or polymers for supports. Examples of inorganic supports are silica, alumina, magnesia, titania, zirconia, clay and mixtures thereof. Formation of a supported catalyst is described in WO 98/49208, the disclosure of which is incorporated herein by reference. The quantity of support material used may range from about 1 to 100,000 grams per gram of the complexed metal present in the catalyst.

The polymerization process may involve temperatures from −100° C. to 250° C. and pressures from atmospheric to 30,000 psig. Solvents suitable for the polymerization process are those that are inert relative to the polymerization and thus allow the polymerization to proceed. Preferred solvents are aliphatic and aromatic hydrocarbons such as methylene chloride and toluene. The polymerization process is conducted for a period of time sufficient to form the polymer.

The catalyst and process for polymerization of this invention provide unique processing advantages in terms of productivity and durability. The catalyst and process display a very high efficiency in producing polymer as measured by the yield ratio of amount of polymer produced per amount of complex used over the actual polymerization reaction. A yield ratio of 2800 has been observed in the examples hereinbelow. Durability of the catalyst activity in the polymerization process is very exceptional. The Ni complex of Example 10 described above was found in polymerization of ethylene to remain active as evidenced by heat evolution over 5 days that included a 2 day shutdown of the reaction system.

An olefin polymer of the present invention is prepared by the process of this invention as claimed or described in this application to include the non-limiting examples hereinbelow.

An ethylene polymer of the present invention has a unique combination of properties which are a number average molecular weight (Mn) of less than 10,000 and branching of about 100 or more methyl-ended branches per 1,000 methylene carbon atoms and a reactivity with the acylating agent maleic anhydride of about 70% or greater. Several of the examples hereinbelow provide details on preparing the ethylene polymer and its exceptionally high reactivity evidenced in thermal condensation reactions with maleic anhydride and in an alkylation reaction of phenol.

The olefin polymer of this invention, to include the ethylene polymer, provides several advantages as a performance chemical and as an intermediate to performance chemicals for use in various applications of commerce. In general the olefin polymers provide a greater variety of performance chemicals. The ethylene polymer and its derivatives have several advantages—a low cost and abundant source in ethylene, chlorine-free polymer and derivatives, and derivatives high in actives content.

A hydrocarbyl-substituted acylating agent of the present invention comprises the reaction product of the olefin polymer of this invention and an unsaturated carboxylic acid or a reactive equivalent thereof, glyoxylic acid or a reactive equivalent thereof, or a mixture of two or more thereof. The olefin polymer can be the ethylene polymer of this invention. The unsaturated carboxylic acid or reactive equivalent thereof includes maleic acid, maleic anhydride, acrylic acid, itaconic acid and fumaric acid. Reactive equivalents of glyoxylic acid include hemiacetal glyoxylate esters. Methods of preparing hydrocarbyl-substituted acylating agents are well known in the art to include direct thermal condensation and Diels-Alder type condensation usually employing chlorination, and several examples herein provide processing details using maleic anhydride.

A dispersant composition of the present invention comprises the reaction product of the hydrocarbyl-substituted acylating agent of this invention and a compound selected from the group consisting of an amine, an alcohol, an amino alcohol, a reactive metal compound or a mixture of two or more thereof. The hydrocarbyl-substituted acylating agent can be derived from the olefin polymer of this invention to include the ethylene polymer. The amine can be ammonia, a monoamine, a polyamine, or any organic compound having at least one reactive

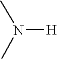

group or a basic nitrogen group such as a basic tertiary nitrogen group. The polyamine can be an alkylenediamine such as ethylenediamine or a polyalkylene-polyamine such as diethylenetriamine. Alcohols include both monools and polyols having 1 to about 22 carbon atoms. Amino alcohols can have 1 to about 50 carbon atoms and include amines having one or more hydroxy groups such as ethanolamine, diethanolamine and dialkylaminoalkanols such as dimethylaminoethanol and diethylaminoethanol. Methods of preparing a dispersant composition from a hydrocarbyl-substituted acylating agent and the group of selected compounds are well known in the art, and U.S. Pat. No. 4,234,435 provides both processing details and equivalents to the group of selected compounds, the disclosure of which is incorporated herein by reference.

A hydrocarbyl-substituted phenol of the present invention comprises the reaction product of the olefin polymer of this invention and phenol. The olefin polymer includes the ethylene polymer of this invention. Methods of alkylating phenol with an olefin polymer are well known in the art, and processing details of alkylating phenol using a BF₃ catalyst are provided in the examples hereinbelow. Hydrocarbyl-substituted phenols can serve as performance chemicals or as intermediates to performance chemicals. These alkylated phenols can be reacted with coupling agents such as formaldehyde, sulfur and glyoxylic acid to form oligomers of two or more phenolic units. These oligomers can serve as performance chemicals or as intermediates to performance chemicals such as nitrogen- or metal-containing detergents. Hydrocarbyl phenols can also be converted to salicylate derivatives which are useful in numerous applications.

A Mannich reaction product of the present invention comprises the reaction product of the hydrocarbyl-substituted phenol of this invention, an aldehyde, and an amine. The hydrocarbyl-substituted phenol can be derived from the olefin polymer of this invention to include the ethylene polymer. The aldehyde can have 1 to about 6 carbon atoms with formaldehyde, in one of its reagent forms such as formalin or paraformaldehyde, being a preferred aldehyde. The amine can be ammonia, a monoamine, a polyamine, an alkanolamine or any organic compound having at least one reactive

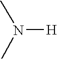

group capable of undergoing a Mannich reaction. Monoamines can be primary or secondary amines having 1 to about 22 carbon atoms. Polyamines can be alkylenediamines such as ethylenediamine and N,N-dimethylpropylenediamine or polyalkylenepolyamines such as diethylenetriamine. Alkanolamines can be primary or secondary amines having 1 to about 22 carbon atoms and one or more hydroxy groups such as ethanolamine and diethanolamine. Methods to prepare Mannich reaction products are well known in the art. Both U.S. Pat. No. 5,876,468 and an example hereinbelow provide processing details for a Mannich reaction.

A hydrocarbyl-substituted aromatic hydrocarbon of the present invention comprises the reaction product of the olefin polymer of this invention and an aromatic hydrocarbon selected from the group consisting of benzene, toluene, xylenes and naphthalene. The olefin polymer includes the ethylene polymer of this invention. Methods to alkylate an aromatic hydrocarbon with an olefin polymer are well known in the art and generally employ an acid catalyst such as AlCl₃ or HF. The alkylated aromatic hydrocarbon can serve as a base fluid, diluent or solvent in various applications and is also an intermediate to metal-containing detergents which find use in a multitude of commercial applications. Methods to prepare detergents are well known in the art and involve sulfonation of the hydrocarbyl-substituted aromatic hydrocarbon using a reagent such as sulfur trioxide to form a sulfonic acid followed by its neutralization with an equivalent of or overbasing with more than an equivalent of a basic metal compound.

The olefin polymer, to include the ethylene polymer, of the present invention can be aminated to form a dispersant or ashless detergent which finds use in various applications. There are several known methods of preparing aminated olefin polymers to include initially chlorinating the polymer, and then reacting the chlorinated polymer with an amine, polyetheramine or aminoalcohol in the presence of a base such as sodium carbonate or sodium hydroxide as described in U.S. Pat. Nos. 5,407,453 and 4,055,402 and 3,755,433, the disclosures of which are incorporated herein by reference.

In other embodiments of the present invention the olefin polymer of this invention or its derivatives can be hydrogenated to provide greater stability for use as performance additives in fuels and lubricants or also as base stocks in the case of the hydrogenated polymers.

In the present invention the olefin polymer, to include the ethylene polymer, and its corresponding derivatives generally have utility as performance chemicals or additives in hydrocarbon fluids which include oils of lubricating viscosity, hydrocarbon fuels and petroleum crudes. Ethylene polymers and their derivatives have excellent solubility in hydrocarbon fluids due to the high degree of branching of the polymer where solubility is defined to be at least 0.001% by weight of a material being incorporated into the hydrocarbon fluid. The olefin polymer and its derivatives can be added directly to a hydrocarbon fluid to form a hydrocarbon fluid composition or can be added to the hydrocarbon fluid as an additive concentrate. An additive concentrate comprises the olefin polymer or a derivative of the olefin polymer and optionally a diluent. The diluent facilitates handling and transfer operations and can be an aliphatic solvent, aromatic solvent, mineral oil, synthetic fluid such as a poly (alpha-olefin) or carboxylate ester, an oil from a plant or animal source, and mixtures of two or more thereof. Depending on the end use of the additive concentrate or hydrocarbon fluid composition other known performance additives can be present in the additive concentrate or hydrocarbon fluid composition. The hydrocarbon fluid composition or additive concentrate is usually prepared by mixing its components at ambient or elevated temperatures until the mixture is homogeneous.

A fuel composition of the present invention comprises a hydrocarbon fuel and the olefin polymer of this invention. The hydrocarbon fuel includes gasoline and diesel fuel. The olefin polymer includes the ethylene polymer of this invention and can function as a viscosity modifier. In other embodiments of the invention a fuel composition comprises the hydrocarbon fuel and a derivative of the olefin polymer. Derivatives of the olefin polymer as described above include the hydrocarbyl-substituted acylating agent and corresponding dispersant composition, the hydrocarbyl-substituted phenol, the Mannich reaction product, the hydrocarbyl-substituted aromatic hydrocarbon as well as its sulfonic acid and sulfonate detergent derivatives and the aminated olefin polymer. Derivatives of the olefin polymer as described above also include salicylate, sulfur coupled, formaldehyde coupled and glyoxylic acid coupled derivatives of hydrocarbyl-substituted phenols. In other embodiments of the present invention a fuel composition comprises a hydrocarbon fuel, at least one component that is the olefin polymer of this invention or a derivative of the olefin polymer, and optionally water or an alcohol such as ethanol where the derivative can function as an emulsifier.

A lubricant composition of the present invention comprises a major amount of an oil of lubricating viscosity and the olefin polymer of this invention. The oil of lubricating viscosity includes mineral oils, synthetic fluids such as poly (alpha-olefins) and carboxylate esters and alkylated benzenes, and oils from plants and animals. The olefin polymer includes the ethylene polymer of this invention and can function as a viscosity modifier. In other embodiments of the invention a lubricant composition comprises a major amount of the oil of lubricating viscosity and a derivative of the olefin polymer as listed above for fuel compositions. In other embodiments of the present invention a lubricant comprises an oil, at least one component that is the olefin polymer of this invention or a derivative thereof, and optionally water or an alcohol where the derivative can function as an emulsifier.

The following non-limiting examples illustrate instances of the invention for the catalyst and its preparation, the polymerization process, the olefin polymer and its derivatives.

### EXAMPLES

I. In Bidentate Ligand and Metal Complex Preparations

In these examples ¹H NMR signal splitting is identified by “s” for singlet, “m” for multiplet, “dd” for doublet of doublet, “dt” for doublet of triplet, “t” for triplet, “d” for doublet, and “q” for quartet.

Metal complexes were prepared under nitrogen atmosphere using a glove box and Schlenk ware handling techniques.

Ligands Ia-Ie were prepared by the depicted reaction scheme below following the procedure of Example 5 for ligand Ie. Their corresponding nickel complexes IIa-IIe from NiBr₂.1,2-dimethoxyethane (NiBr₂DME) were prepared following the procedure of Example 10 for Ni complex IIe. The Pd complex IIIc from ligand Ic was prepared as detailed in Example 11. A nickel complex Vc from ligand Ic was prepared in Example 12 from NiCl₂.1,2-dimethoxyethane.

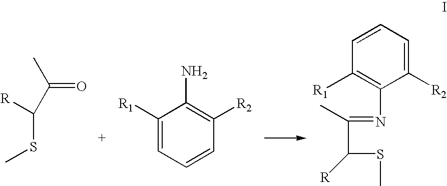

| Ligand | | | | Ni Complex | Pd-Complex |
|---|---|---|---|---|---|
| (example #) | R | R1 | R2 | (example #) | (example #) |
| Ia (1) | H | Me | Me | IIa (6) | |
| Ib (2) | H | Et | Et | IIb (7) | |
| Ic (3) | H | i-Pr | i-Pr | IIc (8) | IIIc (11) |
| Id (4) | H | H | t-Bu | IId (9) | |
| Ie (5) | Me | i-Pr | i-Pr | IIe (10) | |

### Example 5

### Preparation of N-(3-methylthio-2-butylidene)-2,6-diisopropylaniline (Ligand Ie)

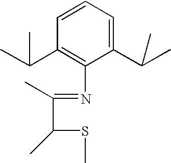

A 50-ml round bottom flask was charged with 2,6-diisopropylaniline, 8.0 g (45.2 mmol), one drop of methanesulfonic acid, 3-(methylthio)-2-butanone, 5.0 g (44.6 mmol), and toluene, 15 ml. The flask was equipped with a Dean Stark trap and heated to 150-160° C. for seven hours. The solvent was removed under reduced pressure and the residue was subjected to vacuum distillation. An amount of 5.0 g (42% yield) of product was obtained. ¹H NMR (CDCl₃, 500 MHz): δ=1.15 (m, 12H); δ=1.54(d, 3H, J=7.1); δ=1.77 (s, 3H); δ=2.20(s, 3H); δ=2.74 (m, 2H); δ=365(q, 1H, J=7.1); δ=7.1(m, 3H).

### Example 10

### Preparation of Complex IIe from Reaction of NiBr₂DME with N-(3-methylthio-2-butylidene)-2,6-diisopropylaniline

A solution of 2.3 g (8.48 mmol) of N-(3-methylthio-2-butylidene)-2,6-diisopropylaniline prepared by the procedure of Example 5 in 5 ml of methylene chloride was added dropwise at room temperature with stirring to 2.0 g (6.47 mmol) of NiBr₂DME in 30 ml of methylene chloride followed by continued stirring for 24 hours. The methylene chloride was removed under reduced pressure. The resultant solid was washed with three 20 ml portions of hexane, and then dried under vacuum to give 3.0 g (94% yield) of a purple-orange solid product. Pure crystalline product was obtained by recrystallizing the product from methylene chloride/hexanes mixture. The product was analyzed by high resolution FT-ESMS, which showed the following peaks: m/z 414.0398 and 907.0026.

### Example 11

### [Pd(N-(1-methylthio-2-propylidene)-2,6-diisopropylaniline)Me(MeCN)]SbF₆ Preparation of IIIc from Reaction of [Pd(CH₃)(CH₃CN)(1,5-cyclooctadiene)]SbF₆ with N-(1-methylthio-2-propylidene)-2,6-diisopropylaniline

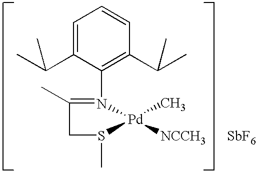

A mixture was prepared of 0.35 g (1.3 mmol) N-(1-methylthio-2-propylidene)-2,6-diisopropylaniline Ic in 5 ml of acetonitrile and 5 ml of methylene chloride, and with stirring at room temperature 0.54 g (1.07 mmol) of [Pd(CH₃)(CH₃CN)(1,5-cyclooctadiene)]SbF₆ (the complex is obtained by: 1) preparing Pd(CH3)Cl(1,5-cyclooctadiene) according to the method of Rulke et alii in Inorg. Chem., 1993, 32, 5769-5778 and 2) preparing [Pd(CH3)(CH3CN)(1,5-cyclooctadiene)]SbF6 from the complex of the first step as described in U.S. Pat. No. 6,034,259 the disclosure of which is incorporated herein by reference) was added. The resultant mixture was stirred for 0.25 hours to effect displacement of 1,5-cyclooctadiene by the bidentate ligand. Solvent (acetonitrile and methylene chloride) were removed under reduced pressure. The resultant solid was washed with hexane and dried to give 0.67 g of a white crystalline solid product. The ¹H NMR (CDCl₃, 500 MHz): δ=7.3 (m, 3H, aromatic), δ=4.4 (broad, 1H, CH₂S), δ=4.2 (broad, 1H, CH₂S), δ=2.75 (broad, 2H), δ=2.71 (s, 3H, CH₃), δ1.99 (s, 3H, CH₃), δ1.38 (s, 3H, CH₃), δ1.34 (d broad, 6H, CH₃), δ1.18 (d broad, 6H, CH₃), δ0.71 (s, 3H, CH₃).

### Example 12

### Preparation of Complex Vc from Reaction of NiCl₂DME with N-(1-methylthio-2-propylidene)-2,6-diisopropylaniline

A solution of 0.54 g (2.03 mmol) of the bidentate ligand Ic in 5 ml of methylene chloride was added dropwise at room temperature with stirring to 0.40 g (1.82 mmol) of NiCl₂DME in 20 ml of methylene chloride followed by continued stirring for 24 hours. The methylene chloride was removed under reduced pressure. The resultant solid was washed with two portions of hexane (20 ml each), and then dried under vacuum to give 0.55 g (77% yield) of yellow solid. The product was analyzed by high resolution ET-ESMS, which showed the following peaks: m/z=619.250 and 747.126.

Ligands If-Ih and Ij were prepared by the depicted reaction scheme below following the procedure of Examples 15a and 15 for ligand Ih. Ligands Ii and Ik were prepared by an alternate route in which the substituted aniline and chloroacetone were initially condensed followed by a second condensation of the aniline-chloroacetone condensate with the sodium mercaptide as detailed in Examples 18a and 18 for ligand Ik. Corresponding Ni complexes IIf-IIk from ligands If-Ik were prepared following the procedure of Example 10 for Ni complex IIe. Pd complexes IIIg and IIIj from ligands Ig and Ij were prepared following the procedure of Example 11 for Pd complex IIIc. Co complex IVg from ligand Ig was prepared as detailed in Example 27. A Ni complex IIh′ from ligand Ih was prepared in Example 28 in which the product was also washed with diethyl ether and tetrahydrofuran in addition to the normal hexane washing.

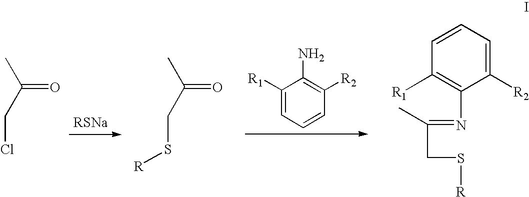

| Ligand | | | | Ni-Complex | Pd-Complex | Co-Complex |
|---|---|---|---|---|---|---|
| (example #) | R | R1 | R2 | (example #) | (example #) | (example #) |
| If (13) | i-Pr | i-Pr | i-Pr | IIf (19) | | |
| Ig (14) | t-Bu | i-Pr | i-Pr | IIg (20) | IIIg (25) | IVg (27) |
| Ih (15) | Ph | Me | Me | IIh (21) | | |
| Ii (16) | 2,6—(Me)₂—C₆H₃ | Me | Me | IIi (22) | | |
| Ij (17) | 2,6—(Me)₂—C₆H₃ | i-Pr | i-Pr | IIj (23) | IIIj (26) | |
| Ik (18) | 4-Cl-C₆H₄ | i-Pr | i-Pr | IIk (24) | | |

### Example 15a

### Preparation of 1-phenylthioacetone

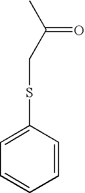

Under a nitrogen atmosphere and while cooling with an ice bath, 1.5 g (0.062 mol) of sodium was mixed with 40 ml of methanol until all the sodium dissolved. A solution of 6.6 g (0.06 mol) of benzenethiol (available from Alfa) in 10 ml of methanol was added to the above sodium solution and then mixed for 0.5 hours followed by addition of 8.0 g (0.087 mole) of chloroacetone (available from Alfa) that resulted in a white solid forming. This mixture was stirred for 0.75 hours before quenching with 0.01 N aqueous NaOH. The crude product was extracted into methylene chloride and dried over MgSO₄. Remolval of methylene chloride gave a low melting solid that was purified by crystallization from hexane to give 8.7 g (80% yield) of product. ¹H NMR (CDCl₃, 500 MHz) δ2.2 (s, 3H, CH₃), δ3.66 (s, 2H, CH₂S), δ7.2 (t, 1H, J=7.7), δ7.28 (t, 2H, J=7.9), δ7.32 (d, 2H, J=7.3). High resolution mass spectrum for C₉H₁₀NSO: 166.04469 calculated; 166.04453 found.

### Example 15

### Preparation of N-(1-phenylthio-2-propylidene)-2,6-dimethylaniline (Ligand Ih)

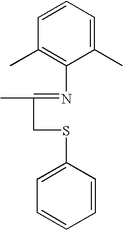

A mixture of 1.8 g (14.9 mmol) of 2,6-dimethylaniline, 2.0 g (13 mmol) of phenylthioacetone, prepared by the procedure of Example 15a, and one drop of methanesulfonic acid in 10 ml of toluene was heated at 120-130° C. for 3 hours while removing water. The reaction mixture was filtered at room temperature through alumina. The filtrate, after adding hexane, was cooled using a dry ice bath, and after standing overnight a crystalline solid formed. The product was isolated by filtration and dried. The yield was 2.5 g (69% yield). ¹H NMR (CDCl₃, 500 MHz): δ1.74 (s, 3H, CH₃), δ=1.78 (s, 6H, CH₃); δ=3.92 (s, 2H, CH₂S); δ=6.85(m); δ=6.94(m); δ=7.3-7.18(m); δ=7.48 (d, 2H, J=7.2).

### Example 18a

### Preparation of N-(1-Chloro-2-propylidene)-2,6-diisopropylaniline

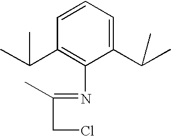

A mixture of 20.0 g (0.11 mole) of 2,6-diisopropylaniline, 13.0 g (0.14 mole) of chloroacetone and one drop of methanesulfonic acid in 10 ml of toluene was heated at 100° C. for 2 hours while removing water using a Dean Stark trap. The reaction mixture was treated with hexanes (20 ml) and stored in dry ice bath overnight. Upon standing overnight in dry-ice bath, solid formed. The reaction was filtered while cold and the filtrate was collected and all volatiles were removed under reduced pressure. Vacuum distillation of the residue gave a pure product as an oil. The yield was 6.0 g of product (21%). ¹H NMR (CDCl₃, 500 MHz): δ=1.13(dd, 12H, J=5.2 Hz, J=1.75 Hz); δ=1.82(s, 3H); δ=2.70(m, 2H); δ=4.28(s, 2H); δ=7.1(m, 3H).

### Example 18

### Preparation of N-(1-(4-chlorophenylthio)-2-propylidene)-2,6-diisopropylaniline (Ligand Ik)

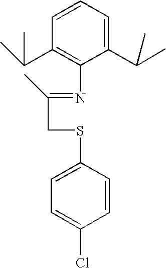

Under a nitrogen atmosphere and while cooling with an ice bath, 0.18 g (7.8 mmol) of sodium was mixed with 40 ml of methanol until all the sodium dissolved. A solution of 4-chlorobenzenethiol (available from Alfa) 1.0 g (6.9 mmol) in 10 ml of methanol was added and then mixed for 0.5 hour with the above dissolved sodium solution. The flask was then charged with a solution of N-(1-Chloro-2-propylidene)-2,6-diisopropylaniline 2.0 g (7.9 mmol) with stirring. After stirring for three hours, the reaction was quenched with 0.01 N NaOH. The crude product was extracted with methylene chloride, washed with water and dried over MgSO₄. Removal of solvent under reduced pressure afforded the product as yellow oil. Pure crystalline product was obtained upon recrystallizing the product from methanol. The yield was 1.8 g (62%). ¹H NMR (CDCl₃, 500 MHz): δ=0.98(dd, 12H, J=6.92); δ=1.76(s, 3H); δ=2.38 (m, 2H); δ=3.91 (s, 2H); δ=7.03(m); δ=7.25(m); δ=7.42(m). High Resolution Electron Impact Mass Spectra; calc. for C₂₁H₂₆NSCl=359.1469 Found=359.1468.

### Example 27

### Preparation of Complex IVg from Reaction of CoCl₂ with N-(1-t-Butylthio-2-propylidene)-2-6-diisopropylaniline

A solution of 0.65 g (2.1 mmol) of N-(1-t-Butylthio-2-propylidene)-2-6-diisopropylaniline in 5 ml of methylene chloride was added dropwise at room temperature with stirring to 0.25 g (1.9 mmol) of CoCl₂ in TBF/methylene chloride mixture (15 ml each) followed by continued stirring for 20 hours. The solvents were removed under reduced pressure. The resultant solid was washed with ether once (40 ml) and twice with 20 ml of hexane, then dried under vacuum to give 0.51 g (61% yield) of product.

### Example 28

### Preparation of Complex IIh′ from Reaction of NiBr₂DME with N-(1-phenylthio-2-propylidene)-2,6-dimethylaniline (a THF Washed Product)

A solution of 1.2 g (4.49 mmol) of N-(1-phenylthio-2-propylidene)-2,6-dimethylaniline, ligand Ih, in 5 ml of methylene chloride was added dropwise at room temperature with stirring to 1.2 g (3.88 mmol) of NiBr₂DME in 15 ml of methylene chloride followed by continued stirring for 20 hours. The methylene chloride was removed under reduced pressure. The resultant solid was washed with 20 ml of hexane, 20 ml of ether and two 20 ml portions of a 1:1 by volume mixture of ether and tetrahydrofuran (THF). The color of the product changed from sticky greenish solid to maroon when washed with the ether-THF mixture. The solid after washing was dried under vacuum to give 1.8 g (96% yield) of maroon product. The product was analyzed by FT-ESMS, which show the following peaks: m/z 405.977 and 890.876.

Ligands Il-In were prepared by the depicted reaction scheme below from respectively benzaldehyde, 9-anthraldehyde and 2-(trifluoromethyl)benzaldehyde following the procedure of Example 29 for ligand Il. The corresponding Ni complexes IIl-IIn from ligands Il-In were prepared following the procedure of Example 10 for Ni complex IIe.

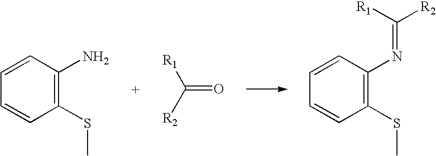

| Ligand | | | Ni Complex |
|---|---|---|---|
| (example #) | R₁ | R₂ | (example #) |
| Il (29) | H | C₆H₅ | IIl (32) |
| Im (30) | H | C₁₅H₉ | IIm (33) |
| In (31) | H | o—CF₃—C₆H₄ | IIn (34) |

### Example 29

### Preparation of N-benzylidene-2-methylthioaniline (Ligand Il)

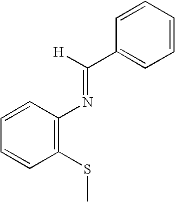

A mixture of 1.3 g (9.35 mmol) 2-methylthioaniline (available from Aldrich), 2.0 g (19.0 mmol) benzaldehyde and one drop of methanesulfonic acid in 5 ml of toluene was heated at 110° C. for 2 hours. Toluene and excess benzaldehyde were removed near room temperature under reduced pressure. The residue was purified by crystallization from an ether-hexane mixture to give 1.0 g (47% yield) of product. ¹H NMR (CDCl₃, 500 MHz): δ8.47 (s, 1H, aromatic), δ=7.9 (m, 2H, aromatic); δ=6.8-7.5(m, 7H, aromatic); δ=2.37 (s, 3H, CH₃S).

II. Polymerization Reactions

Polymerization reactions were set up using glove box and Schlenk ware handling techniques, and were run in an autoclave for ethylene pressures above 5 psig.

Example 35 is representative of the general procedure for polymerizations of ethylene run at 5 psig.

### Example 35

### Ethylene Polymerization Using Complex Ia and Methylaluminoxane

The reactor was charged with a solution of 25 mg of Complex IIa in 50 g of toluene. The reactor was then cooled in an ice bath and charged with 2.6 g of MAO (10% by weight of methylaluminoxane in toluene, available from Aldrich) under an ethylene atmosphere. The cooling bath was removed, and the reaction mixture was stirred under 5-psig ethylene atmosphere, and soon became warm to the touch. After stirring for 1.5 hours, the reaction was quenched with aqueous MeOH/hydrochloric acid. Removal of toluene on a rotavap gave 2.1 g of a colorless oil product. ¹H NMR (CDCl₃, 500 MHz) δ5.8-4.6 (m, vinyl H's), δ1.98 (m, allylic H's), δ1.68-1.59 (m, allylic methyls), δ1.27 (m, methylene and methine H's), δ0.87 (m, nonallylic methyls). The ratio of the methyl protons to the combination of methylene and methine protons is 1:5.1 that corresponds to 196 methyl-ended branches per 1,000 methylenes. The product has a number average molecular weight (Mn) of 778 based on ¹H NMR integration data for the olefinic and aliphatic signals.

The general procedure for polymerizations run above 5 psig was to conduct the reaction in a Parr Reactor. The catalyst was transferred to the reactor as toluene solution via canula followed by MAO, then charged with ethylene (continuous supply) to the desired pressure. After stirring for the designated period of time, the reaction was vented, quenched with HCl/MeOH/H₂O, filtered, and solvent removed using a rotavap.

Example 75 is representative of polymerizations of ethylene done with a palladium catalyst.

### Example 75

### Ethylene Polymerization Using Complex IIIc of Example 11

The Parr reactor was charged with a solution of 0.2 g (0.3 mmol) Complex IIIc (prepared as in Example 11) in 350 g of methylene chloride and 400-psig of ethylene with stirring. The reaction mixture was stinted for 3.5 hours before venting pressurized ethylene. Volatiles were removed under reduced pressure to give 5.9 g of colorless oil as product. ¹H NMR (CDCl₃, 500 MHz): δ=5.4 (in, vinyl H's), δ=1.97 (allylic H's), δ=1.65 (allylic methyl), δ=1.27 (methylene and methine H's), δ=1.05-0.8 (nonallylic methyl). Based on ¹H NMR data, there are 275 methyl-ended branches per 1,000 methylenes. The product has a Mn of 200 based on ¹H NMR integration data for the olefinic and aliphatic signals.

The following Table 1 of ethylene polymerizations provides instances of the catalyst, polymerization process and ethylene polymer of the present invention.

Ethylene Polymerizations

| Example^{a}/ | catalyst, | MAO, | Solvent, g/ | ethylene, | Yield^{c}, g/ | 1H NMR Mn/ | |
|---|---|---|---|---|---|---|---|
| Complex | mmol | mmol | time, hr. | psig | Yield Ratio^{d} | GPC Mn | Branching^{f} |
| 35/IIa | 0.058 | 4.4 | 50/1.5 | 5 | 2.1/84 | 778 | 196 |
| 36/IIa | 0.061 | 5.1 | 50/4 | 5 | 7.3/281 | 784 | 178 |
| 37IIa | 0.117 | 5.1 | 50/4 | 5 | 10.7/214 | 784 | 179 |
| 38/IIa | 0.117 | 23.8 | 50/3.7 | 5 | 12.0/214 | 826 | 170 |
| 39/IIa | 0.115 | 9.48 | 60/3.5 | 5 | 19.5/398 | 688 | 194 |
| 40/IIa | 0.23 | 16.72 | 250/5 | 100 | 280/2800 | 798 | 172 |
| 41/IIa | 0.234 | 12 | 100/4.5 | 150 | 13.2/132 | 756 | 175 |
| 42/IIa | 0.117 | 6.9 | 100/4 | 150 | 11.8/236 | 866 | 175 |
| 43/IIa | 0.0587 | 6.03 | 100/4 | 150 | 18/720 | 856 | 163 |
| 44/IIa | 0.117 | 12 | 182/4 | 150 | 28/560 | 812/1066 | 180 |
| 45/Vc | 509 | 18.9 | 240/4 | 100 | 55/458 | 602 | 177 |
| 46/IIb | 0.1145 | 9.1 | 60/3.5 | 5 | 10.1/194 | 980/1187 | 196 |
| 47/IIb | 0.166 | 16.4 | 325/8^{b} | 80 | 100/1334 | 870/1302 | 179 |
| 48/IIb | 0.22 | 19.7 | 330/7 | 100 | 176/1760 | 770 | 163 |
| 49/IIc | 0.206 | 20.7 | 100/3.5 | 5 | 13.5/135 | 700/924 | 192 |
| 50/IIc | 0.1245 | 10.68 | 240/4 | 150 | 55.5/925 | 576/875 | 174 |
| 51/IIc | 0.1245 | 10.68 | 200/4^{b} | 400 | 90/1580 | 588 | 173 |
| 52/IIc | 0.25 | 21.37 | 440/8^{b} | 100 | 125/1042 | 826/1155 | 131 |
| 53/IIc | 0.311 | 26.7 | 570/8^{b} | 100 | 260/1733 | 840 | 130 |
| 54/IIc | 0.207 | 16.8 | 260/3 | 100 | 56/560 | 826 | 169 |
| 55/IId | 0.055 | 5.9 | 50/4 | 5 | 6/240 | 560 | 189 |
| 56/IIe | 0.209 | 17.4 | 202/5 | 100 | 55/529 | 1526/2397 | 149 |
| 57/IIe | 0.2 | 18.1 | 208/24 | 100 | 182/1820 | 1596 | 141 |
| 58/IIf | 0.196 | 18.8 | 200/7 | 100 | 25/250 | 1246/1970 | 144 |
| 59/IIf | 0.21 | 8.6 | 200/4 | 100 | 14/140 | 1260 | 147 |
| 60/IIf | 0.393 | 22.8 | 320/11 | 100 | 120/600 | 1246/1823 | 147 |
| 61/IIg | 0.143 | 17.2 | 200/4 | 100 | 27/360 | 4900/6229 | 115 |
| 62/IIg | 0.238 | 28.2 | 340/7 | 100 | 16.4/131 | 4592(NMR) | 120 |
| 63/IIg | 0.143 | 17.7 | 208 | 100 | 18/240 | 5348(NMR) | 118 |
| 64/IIh′ | 0.22 | 15.7 | 210/6 | 5 | 20/200 | 1400/2113 | 157 |
| 65/IIh′ | 0.11 | 8.6 | 220/6 | 5 | 40/800 | 1640/2376 | 143 |
| 66/IIh′ | 0.44 | 36.2 | 820/6 | 300 | 68/340 | 1792 | 117 |
| 67/IIh | 0.205 | 17.2 | 244/2 | 100 | 20/200 | rubbery solid | |
| 68/IIj | 0.2 | 19 | 370/2 | 100 | 20/181 | powdery solid | |
| 69/IIk | 0.086 | 7.4 | 205/4 | 100 | 8/160 | rubbery solid | |
| 70/IIl | 0.044 | 4 | 50/1 | 5 | ^{e}/52 | | |
| 71/IIl | 0.045 | 3.9 | 50/1 | 100 | ^{e}/52 | | |
| 72/IIm | 0.048 | 4 | 30/1 | 5 | ^{e}/38 | | |
| 73/IIm | 0.092 | 7.3 | 50/1 | 430 | ^{e}/38 | | |
| 74/IIn | 0.038 | 5.25 | 30/1 | 5 | ^{e}/33 | | |
| 75/IIIc | 0.3025 | | 350/3.5 | 400 | 5.9/30 | 200 | 275 |
| 76/IIIg | 0.085 | | 175/0.15 | 700 | 1.5/166 | 532 | 150 |
| 77/IIIj | 0.133 | | 270/1 | 700 | 0.3/3 | 700 | 160 |
| 78/IVg | 0.059 | 5.17 | 90/2 | 120 | ^{e}/77 | | |

^{a}Examples 35-74 involved polymerizations done with a Ni catalyst, Examples 75-77 used a Pd catalyst, and Example 78 used a Co catalyst.
^{b}The ethylene source was shut off after the indicated time, and the reaction mixture was stirred overnight before quenching.
^{c}Yield is polymer product obtained in grams.
^{d}Yield ratio is grams of polymer obtained per gram of complex.
^{e}Analysis by GCMS and H¹NMR indicated formation of a product that was a mixture of C₄-C₄₀ olefins.
^{f}Branching is the number of methyl-ended branches per 1,000 methylene carbons.

Examples 79 and 80 involve copolymerizations of the present invention.

### Example 79

### Copolymerization of Ethylene and 1-Octene Using Complex IIc and Methylaluminoxane

The reactor was charged with 75 mg (0.1545 mmol) of Complex IIc, 270 g of toluene and 12.0 g (107.1 mmol) of 1-octene. Next, 7.8 g of MAO (13.4 mmol) was charged followed by a continuous supply of ethylene at 100 psig, and the reaction mixture was stirred for 7 hours while keeping the temperature at 25° C. The ethylene supply was shut off, and stirring was continued overnight. GCMS analysis of the reaction mixture indicated the presence of a mixture of C₈-C₃₂ olefins. The reaction mixture was quenched with hydrochloric acid in a water-methanol mixture. Removal of toluene on a rotavoap gave 138 g (activity is 1.67 Kg of polymer per gram of complex) of a hazy oil product. ¹H NMR (CDCl₃, 500 MHz) δ5.38 (m, vinyl H's), δ2.01-1.95 (m, allylic H's), δ1.60-1.55 (m, allylic methyls), δ1.27 (broad, methylene and methine H's), δ0.89 (m, nonallylic methyls). The ratio of methyl H's to combined methylene and methine H's corresponds to 63 methyl-ended branches per 1,000 methylenes, while integration data for aliphatic H's and olefinic H's indicates a Mn of 714.

### Example 80

### Copolymerization of Ethylene and Propylene Using Complex IIc and Methylaluminoxane

A 2-liter Parr reactor was charged with 30 mg (0.0618 mmol) of Complex IIc and 380 g of toluene. Next, 10.8 g of MAO (18.6 mmol) was charged followed by with stirring ethylene to 50 psig, then propylene to 100 psig, and finally ethylene to 200 psig. The reaction mixture was stirred for 5 hours during which the pressure twice dropped to 100 psig and was each time brought back to 150 psig with propylene. The reaction mixture was quenched with aqueous hydrochloric acid. Removal of toluene on a rotavap gave 157 g (activity is 1570 g of polymer per gram of complex) of a colorless oil product. ¹H NMR (CDCl₃, 500 MHz) δ4.48 (m, vinyl H's), δ1.96 (m, allylic H's), δ1.64-1.56 (m, allylic methyls), δ1.26 (m, methylene and methine H's), δ0.85 (m, nonallylic methyls). The ratio of methyl H's to combined methylene and methine H's indicates 200 methyl-ended branches per 1,000 methylenes. The integration data for aliphatic H's and olefinic H's indicates a Mn of 574. GCMS analysis run on the reaction mixture before quenching indicated the presence of a mixture of olefins that included C₅, C₇, C₉, C₁₁ and C₁₃ olefins, formed from the copolymerization of ethylene and propylene, although signal intensities were less for odd-numbered olefins relative to even-numbered olefins.

Examples 81 and 82 demonstrate the effect of temperature on catalyst activity and on molecular weight and branching of ethylene polymers.

### Example 81

A solution of complex IIc 0.1 g (0.27 mmol) in 167 g toluene was charged to a Parr reactor. The reactor and its contents were cooled to 7° C. then charged with MAO 10.3 g (17 mmol) while stirring. The reactor was then charged with ethylene at 100 psig. The temperature started going up and in few minutes it reached 35° C. The temperature of the reaction was controlled in the range of 31-38° C. by means of a water bath. After three hours the reaction was vented and quenched with MeOH/HCl/H₂O. An amount of 70.0 g polymer was obtained after removing toluene under reduced pressure. The Mn of the polymer determined by H-NMR was 612 and the total number of branches was 182.

### Example 82

A solution of complex IIc 0.1 g (0.277 mmol) in 196 g toluene was charged to a Parr reactor. The reactor and its contents were heated to 45° C. then charged with MAO 11.3 g (19.4 mmol) while stirring. The reactor was then charged with ethylene at 120 psig. The temperature of the reaction was kept at 45°+ or −2°. After stirring for two hours under continuous supply of ethylene, the reaction was vented, quenched with MeOH/HCl/H2O and filtered. An amount of 43 g polymer was obtained after removing toluene under reduced pressure. The Mn of the polymer determined by H-NMR was 586 and the total number of branches was 181.

Examples 83-86 of Table 2 show the effect of the mole ratio of the cocatalyst to the metal complex on polymerizations of ethylene.

TABLE 2
Effect of Cocatalyst to Metal Complex Mole Ratio

| Example^{a} | Complex | Al/Ni^{b} | Mn (H-NMR) | TOF^{c} |
|---|---|---|---|---|
| 83 | IIc | 81 | 812 | 1928 |
| 84 | IIc | 340 | 658 | 5086 |
| 85 | IIc | 741 | 602 | 2630 |
| 86 | IIc | 1115 | 600 | 3381 |

^{a}Polymerization of ethylene was done following the procedure of Example 82.
^{b}Al/Ni is the mole ratio of methylaluminoxane to Ni complex IIc.
^{c}TOF is turn over frequency of the catalyst measured as moles of ethylene consumed per mole of catalyst.

III. Viscosity Performance and Derivative Preparations of Branched Polyethylene

Examples 87-89 in Table 3 on polyethylene viscosity performance demonstrate the oil solubility and viscosity modifier performance of the polyethylenes of the present invention.

TABLE 3
Polyethylene Viscosity Performance

| | Treat | | | | |
|---|---|---|---|---|---|
| | Rate^{c}, | cSt @ | cSt @ | | Shear |
| Example | wt % | 40° C. | 100° C. | VI | Loss, % |
| 87^{a} | 10 | — | 8.94 | — | — |
| 88^{b} | 5 | 72.7 | 10.4 | 129 | 14.6^{d} |
| 89^{b} | 10 | 117.3 | 16.1 | 147 | 4.6^{e} |

^{a}Polyethylene was Example 66 from Table 1 having a Mn of 1792 and 117 methyl ended branches per 1000 methylenes.
^{b}Polyethylene was a blend of several polymerizations using Ni complex IIg where polymer blend had a Mn of 6830 and 120 methyl ended branches per 1000 methylenes.
^{c}Treat rate was 5-10% by wt. polymer in a mineral oil having a viscosity of 5.85-5.88 cSt @ 100° C.
^{d}Shear loss was measured by KRL bearing 20 hour shear test.
^{e}Shear loss was measured by sonic shear test.

Examples 90-93 of Table 4 show the high reactivity of the ethylene polymer of the present invention in preparing derivatives.

TABLE 4
Reactivity of Ethylene Polymers

| | Polyethylene | | % Wt Unreacted Polymer per |
|---|---|---|---|
| Example | Mn | Derivative | TLC-FID^{c}/Col. Chrom.^{d} |
| 90 | 848 | alkenylsuccinic | 9/3.6 |
| | | anhydride^{a} | |
| 91 | 2507 | alkenylsuccinic | 29/27.6 |
| | | anhydride^{a} | |
| 92 | 1823 | alkenylsuccinic | 19.4 |
| | | anhydride^{a} | |
| 93 | 942 | alkylphenol^{b} | 7.7 |
| ^{a}In Examples 90-92 the polymer was reacted with maleic anhydride in a 1:3 molar ratio of polymer to maleic anhydride by heating under a nitrogen atmosphere at 195° C. for 24 hours followed by vacuum stripping at 215° C. and filtration. | | | |
| ^{b}In Example 93 the polymer was reacted with phenol in a 1:3.7 molar ratio of polymer to phenol using 60 mole % of BF₃ · 2 Phenol catalyst at 40° C. for 7 hours followed by quenching of the catalyst with base, filtration and vacuum stripping at 218° C. to remove unreacted phenol. | | | |
| ^{c}Using a TLC-FID analyzer the procedure for thin layer of chromatography with flame ionization detection involved dissolving a sample of the derivative at about 2.5% by weight in hexane. A portion of this sample solution was double developed on a silica coated rod using pentane followed by toluene. The separated components on the rod were detected by hydrogen flame ionization current as the percent of their peak area to total peak area. | | | |
| ^{d}Column chromatography—the procedure involved preparing a column from about 5 grams of silica gel, about 1 gram of an acidified montmorillonite clay (Superfiltrol ™ from Englehard having an acidity of 5 mg KOH per gram of the clay), and naphtha. About 0.5-0.7 grams of a derivative sample was dissolved in about 30 ml of naphtha and eluted off the column using additional naphtha until about 100 ml of effluent was collected | | | |
| #in a tared receiver. Naphtha was removed from the effluent via a steam bath followed by a vacuum oven at room temperature to give a residue. The percent by weight unreacted polymer was the percent ratio of the residue weight to the weight of the derivative sample. | | | |

Examples 94 and 95 are succinimide dispersant and Mannich detergent/dispersant derivatives of the polyethylene of the present invention. The succinimide dispersant of Example 94 was found to be equivalent to better than standard dispersants derived from polyisobutylene in soot dispersancy testing.

### Example 94

### Preparation of Polyethylene Succinimide Dispersant

The alkenylsuccinic anhydride of Example 91, having a total acid number of 69, was diluted with oil to give a product having 50% diluent and heated to 100° C. Polyethylenepolyamine bottoms were added to the diluted anhydride at 100-110° C. in a ratio of carbonyl to nitrogen of 6CO:5N. This mixture was heated to 150° C., held at 150° C. for 4 hours, and then filtered to give a product having a 0.67% nitrogen content.

### Example 95

### Preparation of Polyethylene Mannich Detergent

A flask was charged with the alkylphenol of Example 93 (108.6 g, 0.134 mole), paraformaldehyde 4.72 g (0.143 mole), dimethylaminopropylamine 14.62 g (0.143 mole) and two drops of saturated aqueous sodium hydroxide solution. The reaction mixture was heated to 95° C. Soon after, the reaction became exothermic with the temperature rising to 108° C. and solids starting to dissolve. The reaction mixture was heated to 135° C., held there for 2.5 hours, and filtered to give 115.5 grams of product.

What is claimed:

1. A catalyst for use in polymerization of olefins or olefin-containing compounds, comprising:
(a) a metal complex prepared by reacting a metal compound, wherein the metal is selected from the group consisting of transition metals, boron, aluminum, germanium, and tin, with a bidentate ligand selected from the group consisting of 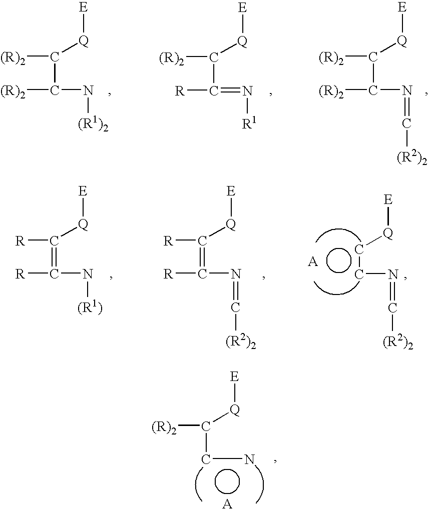
wherein Q is O, S, Se or Te; E, R, R¹ and R² are independently hydrogen, hydrocarbyl, cationic counterion or taken together to form a ring are hydrocarbylene provided that E is hydrocarbyl or hydrocarbylene when Q is O; and A is a divalent group that forms an aromatic ring and can include N, O and S atoms; and optionally
(b) an activating compound capable of reacting with the metal complex to form the catalyst.

2. The catalyst of claim 1 wherein Q is sulfur.

3. The catalyst of claim 1 wherein the metal of the metal compound is Co, Ni, Pd or Pt.

4. The catalyst of claim 3 wherein Q is sulfur.

5. The catalyst of claim 4 wherein the activating compound is selected from the group consisting of organoaluminum compounds, alkylaluminoxanes, fluorohydrocarbylboron compounds, acids of noncoordinating anions, acidic silicas, acidic aluminas, acidic clays and acidic zirconias.

6. The catalyst of claim 4 wherein the bidentate ligand is selected from the group consisting of

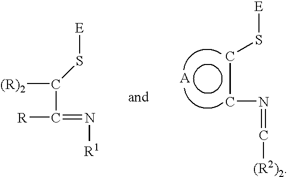

7. A catalyst for use in polymerization of olefins or olefin-containing compounds, comprising:
(a) a metal complex prepared by reacting a metal compound, wherein the metal is selected from the group consisting of transition metals, boron, aluminum, germanium, and tin, with a bidentate ligand selected from the group consisting of 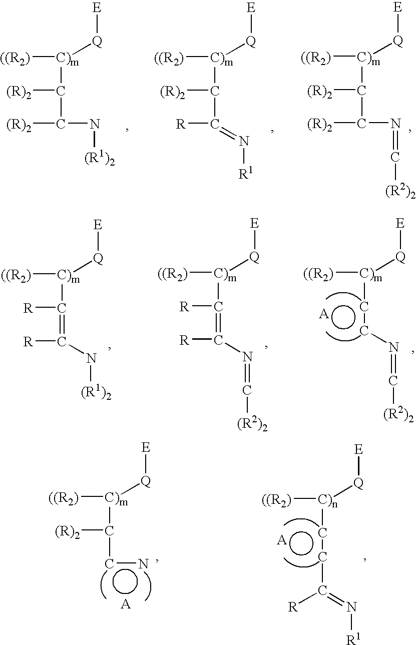
wherein Q is O, S, Se or Te; E, R, R¹ and R² are independently hydrogen, hydrocarbyl, cationic counterion, or taken together to form a ring are hydrocarbylene provided that E is hydrocarbyl or hydrocarbylene when Q is O; m is 1 or 2; A is a divalent group that forms an aromatic ring and can include N, O and S atoms; and n is 0 or 1; and optionally
(b) an activating compound capable of reacting with the metal complex to form the catalyst.

8. A process for the polymerization of olefins or olefin-containing compounds comprising contacting olefins or olefin-containing compounds under polymerization conditions with the catalyst of claim 1.

9. A process for the polymerization of olefins or olefin-containing compounds comprising contacting olefins or olefin-containing compounds under polymerization conditions with the catalyst of claim 6.

10. A process for the polymerization of olefins or olefin-containing compounds comprising contacting olefins or olefin-containing compounds under polymerization conditions with the catalyst of claim 7.

11. An olefin polymer prepared by the process of claim 8.

12. An olefin polymer prepared by the process of claim 9.

13. An olefin polymer prepared by the process of claim 10.

14. An ethylene polymer wherein the polymer has a number average molecular weight of less than 10,000, branching of about 100 or more methyl-ended branches per 1,000 methylene carbon atoms and a reactivity with the acylating agent maleic anhydride of about 70% by weight or greater.

15. A hydrocarbyl-substituted acylating agent comprising the reaction product of the olefin polymer of claim 12 and an unsaturated carboxylic acid or a reactive equivalent thereof, glyoxylic acid or a reactive equivalent thereof, or a mixture of two or more thereof.

16. The hydrocarbyl-substituted acylating agent of claim 15 wherein the reactive equivalent of the unsaturated carboxylic acid is maleic anhydride.

17. A dispersant composition comprising the reaction product of the hydrocarbyl-substituted acylating agent of claim 15 and a compound selected from the group consisting of an amine, an alcohol, an amino alcohol, a reactive metal compound, or a mixture of two or more thereof.

18. The dispersant composition of claim 17 wherein the compound is a polyalkylenepolyamine or a dialkylaminoalkanol.

19. A hydrocarbyl-substituted phenol comprising the reaction product of the olefin polymer of claim 12 and phenol.

20. A Mannich reaction product comprising the reaction product of the hydrocarbyl-substituted phenol of claim 19, an aldehyde, and an amine.

21. A hydrocarbyl-substituted aromatic hydrocarbon comprising the reaction product of the olefin polymer of claim 12 and an aromatic hydrocarbon selected from the group consisting of benzene, toluene, xylenes and naphthalene.

22. A hydrocarbyl-substituted acylating agent comprising the reaction product of the ethylene polymer of claim 14 and an unsaturated carboxylic acid or a reactive equivalent thereof, glyoxylic acid or a reactive equivalent thereof, or a mixture of two or more thereof.

23. The hydrocarbyl-substituted acylating agent of claim 22 wherein the reactive equivalent of the unsaturated carboxylic acid is maleic anhydride.

24. A dispersant composition comprising the reaction product of the hydrocarbyl-substituted acylating agent of claim 22 and a compound selected from the group consisting of an amine, an alcohol, an amino alcohol, a reactive metal compound, or a mixture of two or more thereof.

25. The dispersant composition of claim 24 wherein the compound is a polyalkylenepolyamine or a dialkylaminoalkanol.

26. A hydrocarbyl-substituted phenol comprising the reaction product of the ethylene polymer of claim 14 and phenol.

27. A Mannich reaction product comprising the reaction product of the hydrocarbyl-substituted phenol of claim 26, an aldehyde, and an amine.

28. A hydrocarbyl-substituted aromatic hydrocarbon comprising the reaction product of the ethylene polymer of claim 14 and an aromatic hydrocarbon selected from the group consisting of benzene, toluene, xylenes and naphthalene.

29. A fuel composition comprising a hydrocarbon fuel, the olefin polymer of claim 12, and optionally water.

30. A lubricant composition comprising a major amount of an oil of lubricating viscosity and the olefin polymer of claim 12.

31. A fuel composition comprising a hydrocarbon fuel, the ethylene polymer of claim 14, and optionally water.

32. A lubricant composition comprising a major amount of an oil of lubricating viscosity and the ethylene polymer of claim 14.

33. A lubricant composition comprising a major amount of an oil of lubricating viscosity and and the dispersant composition of claim 17.

34. A fuel composition comprising a hydrocarbon fuel, the dispersant composition of claim 17, and optionally water.

35. A fuel composition comprising a hydrocarbon fuel, the Mannich reaction product of claim 20, and optionally water.
